(19) United States
(12) Patent Application Publication
(10) Pub. No.: US 2016/0164934 A1
(43) Pub. Date: Jun. 9, 2016

(54) INTERACTIVE JUKEBOX SYSTEM AND DISPLAY

(71) Applicants: Clauis Adell Hendon, III, Parkville, MO (US); Gaurub Pandey, Pittsburgh, PA (US); Nishant Karki, Kathmandu (NP)

(72) Inventors: Clauis Adell Hendon, III, Parkville, MO (US); Gaurub Pandey, Pittsburgh, PA (US); Nishant Karki, Kathmandu (NP)

(21) Appl. No.: 14/563,330

(22) Filed: Dec. 8, 2014

(51) Int. Cl. H04L 29/06; H04L 29/08; G06F 17/30; H04W 4/04; G06Q 20/40

(52) U.S. Cl. CPC H04L 65/4076; H04W 4/043; G06Q 20/40; G06F 17/3053; G06F 17/30769; G06F 17/30106; H04L 67/06

(57) ABSTRACT

An interactive jukebox system. The system includes a local controller located at a venue and a central server located remotely to the venue. Patrons of the venue can use their private mobile devices to select content to be broadcast at the venue. The patrons' selections are communicated to the central server. The central server tallies the selections of a plurality of patrons at the venue and provides the local controller with a ranked ordering of content to be broadcast at the venue. The local controller broadcasts the content in the ranked order. A dashboard display is provided on a display device at the venue and presents information associated with current and upcoming broadcasts of content, messages posted by patrons, videos, and advertisements. A DJ mode is provided in which the ranked order of content is provided to a DJ at the venue to aid selection of content for broadcast.

### BACKGROUND

The use of jukeboxes in commercial establishments such as bars, restaurants, cafes, and/or clubs is well known and has been available for many years. Jukebox systems provide users with the opportunity to select, order, and reproduce or display a musical or audiovisual work at the commercial establishment on demand for the payment of a fee.

Initially, jukeboxes consisted of mechanical, standalone phonorecord devices that physically stored records in the jukebox. Over time, jukeboxes transitioned to compact disc players with musical and visual content stored in the device in the form of compact musical and/or video disks. These conventional standalone phonorecord or CD jukebox systems are now being replaced by digital downloading jukebox systems that typically include a central server and remote jukebox devices that are capable of remotely communicating with each other.

The central server contains digital storage means that maintain a master library of audio (consisting of music) and/or audiovisual (typically music and associated video or graphic) works. The central server also includes control software and a modem or some other form of telecommunications equipment for communicating with the remote jukebox devices to: transmit content to the remote jukebox devices; deliver new content to the remote jukebox devices; monitor the operation of the remote jukebox devices; provide updates to the operating software in the remote jukebox devices; and monitor the music selected at the remote jukebox devices to properly account for royalties to be paid to artists and/or music owners.

The remote jukebox devices are typically wall- or floor-mounted units that include microprocessor-based computing devices that are equipped with digital storage capacity (such as a memory/storage hard drive) for storing musical and/or audiovisual content at the device to facilitate access when a work stored in the device is selected. Each remote jukebox also typically includes a modem or other telecommunications equipment for communicating with the central server, a payment receiving receptacle capable of receiving either cash or a credit/debit card payment, a input device such as a touch screen for displaying user information and ordering songs or audiovisual works for reproduction at the commercial establishment, and a video display for showing song related videos or graphics and/or advertising or promotional materials. Through its control circuitry, the jukebox device is capable of controlling the storage of musical content in the remote jukebox device, interfacing with the touch screen, accessing musical/audiovisual content stored in the device, communicating with the central server, and driving the attached displays.

In these known systems, a patron at the commercial establishment is permitted to access a listing of the musical/audiovisual content that is available on the system. At the request of a user, a listing of the available musical/audiovisual content is shown on the touch screen at the remote jukebox device. Due to size limitations, the remote jukebox device tends to store less content than the central server but permits the user to access the broader content at the central server for an added charge. Upon locating a desired musical or audiovisual work, the patron is then required to deposit cash or bills, a credit card, or other credit medium into the bill/credit card receptor. Upon payment, the patron is permitted to select the desired musical or audiovisual work for reproduction at the commercial establishment. If the selected work is stored at the remote jukebox device, the microprocessor accesses the work, reads the file, and then reproduces the musical work or audiovisual work through audio/video circuitry contained in the device. If the selected work is not stored at the remote jukebox device but is stored at the central server, the central server sends the selected work to the remote jukebox device where it is read and reproduced.

A substantial disadvantage of existing jukebox systems is that they are equipment intensive. The original versions of jukeboxes consisted of self contained devices that stored either phonorecords or compact discs. These original devices were not only bulky in size but were also expensive and required constant updating by route men who had to physically go to each commercial establishment to repair the device or replace outdated content with new content. While current systems are easier to update and administer from a remote location, they still require that a remote jukebox device having a dedicated internal storage be located at the commercial establishment at a substantial cost to the owner of the establishment. An added disadvantage of these systems is that there is only one contact point (i.e., the jukebox device) where users can access the system and select musical or audiovisual works for reproduction at the commercial establishment.

The availability of a single contact point is a substantial defect in current systems because it requires a potential user to leave his or her acquaintances and the table, booth, or other spot in the establishment where they are located and go to the remote jukebox device to access the system and select an available song for reproduction at the commercial establishment. This requirement breaks up a potential user's continuity of interaction with his or her acquaintances at the commercial establishment and requires the potential user to physically go to the contact point. By limiting access to the system to a single remote jukebox device, potential users are dissuaded from using the system and playing songs because of the interruption of his or her social interaction with his or her acquaintances in order to go to the jukebox device to review the playlist and order a song.

These current systems fail to engage users and potential income streams associated with patrons of a business that are not standing or located within close proximity to the remote jukebox device. A jukebox system that can be accessed by patrons no matter their location within a venue and that can provide interaction and advertisement opportunities to those patrons and the venue is needed. Such a system that can also provide cross-venue and/or social media interaction between patrons would also be a valuable improvement on the current art. A jukebox system that is not limited by constraints, such as memory space, of a freestanding unit in a venue and that enables access to a full library of content would also be an improvement in the art.

### SUMMARY

Embodiments of the invention are defined by the claims below, not this summary. A high-level overview of various aspects of the invention is provided here to introduce a selection of concepts that are further described in the Detailed-Description section below. This summary is not intended to identify key features or essential features of the claimed subject matter, nor is it intended to be used in isolation to determine the scope of the claimed subject matter. In brief, this disclosure describes, among other things, an interactive jukebox system.

The jukebox system includes a central server located separately or remotely from a number of commercial establishments or venues that are served by the central server. Each venue includes a local controller, a sound system, and a display device. The local controller is communicatively coupled to the central server. Audio and/or audiovisual content (hereinafter referred to generally as content) is provided by the central server to the local controller for broadcast at the venue via the sound system and display device.

Patrons of the venue are provided access for interaction with the jukebox system via an application executing on the patron's mobile device, e.g. smartphone, tablet computer, laptop computer, or similar device. To initiate the interaction, the location of the patron's mobile device is determined to be at the venue such as by selection of the venue from a list presented on the mobile device and/or through determining a location of the mobile device using a global positioning system (GPS) associated with the mobile device. Through the application executing on the mobile device, a patron can access a content library stored in the central server, vote on or select content that the patron would like to have broadcast at the venue, deliver text messages and/or images to be posted on the displays at the venue, and pay for priority broadcast of the content selected by the patron.

The voting and selection options thus provide patrons the opportunity to control what content is broadcast at the venue. Enabling patrons to post messages on the display for viewing by other patrons of the venue may also increase patron interaction and enjoyment while at the venue.

The system can be operated in a disc jockey mode in which selections or votes received from the patrons are provided to a disc jockey. The disc jockey may then utilize the information to select particular content for broadcast based upon the preferences expressed by the patrons at the venue. In this way, patrons have a direct input into the content broadcast by the disc jockey thereby increasing their interest and enjoyment of the content broadcast at the establishment and providing a more enjoyable experience at the establishment.

The display associated with the interactive jukebox system presents a dashboard view that presents information such as a current queue of content, e.g. songs to be played, information regarding the content currently being broadcast, posted messages received from patrons, and advertisements. The dashboard may be presented on video displays located throughout the venue to provide more visibility and interaction between the system and the patrons.

### DESCRIPTION OF THE DRAWINGS

Illustrative embodiments of the invention are described in detail below with reference to the attached drawing figures, and wherein:

FIG. 1 is a block diagram depicting an exemplary computing device and operating environment that is suitable for use in embodiments of the invention;

FIG. 2 is a block diagram of an exemplary interactive jukebox system depicted in accordance with an embodiment of the invention;

FIG. 3 is a perspective view of a display device presenting a dashboard display depicted in accordance with an embodiment of the invention;

FIG. 4A is an illustrative view of a mobile device executing an interactive jukebox application and presenting a venue-selection page of the application on a display thereof in accordance with an embodiment of the invention;

FIG. 4B is an illustrative view of the mobile device of FIG. 4A presenting an options page of the interactive jukebox application;

FIG. 4C is an illustrative view of the mobile device of FIG. 4A presenting a current-content page of the interactive jukebox application;

FIG. 4D is an illustrative view of the mobile device of FIG. 4A presenting a listing of content approved for broadcast at a venue by the interactive jukebox application;

FIG. 4E is an illustrative view of the mobile device of FIG. 4A presenting a payment page of the interactive jukebox application;

FIG. 4F is an illustrative view of the mobile device of FIG. 4A presenting a messaging page of the interactive jukebox application;

FIGS. 5A-B depict a flow diagram of a method for providing content at a venue in accordance with an embodiment of the invention;

FIG. 6 is a flow diagram depicting a method for presenting a captured video stream at a venue in accordance with an embodiment of the invention;

FIG. 7 is a flow diagram depicting a method for presenting messages posted by patrons of a venue in accordance with an embodiment of the invention; and

FIG. 8 is a flow diagram depicting a method for operation of an interactive jukebox system in a disc jockey mode in accordance with an embodiment of the invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

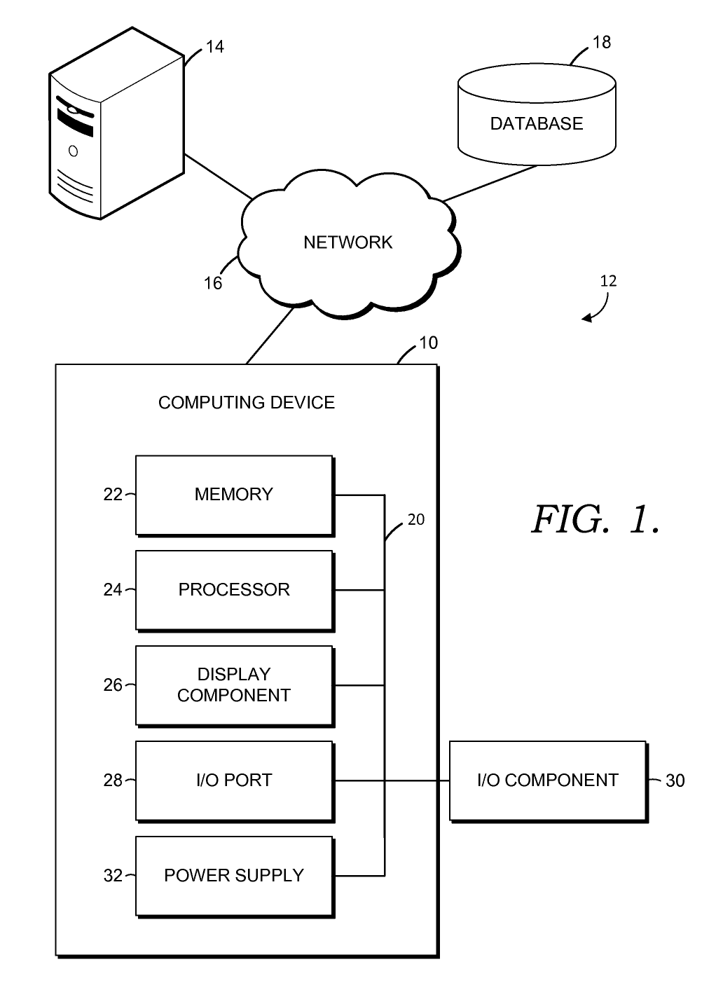

With initial reference to FIG. 1, an exemplary computing device 10 for use in implementing embodiments of the invention is shown in accordance with an embodiment of the invention. The computing device 10 is but one example of a suitable computing device and is not intended to suggest any limitation as to the scope of use or functionality of embodiments of the invention. The computing device 10 should not be interpreted as having any dependency or requirement relating to any one or combination of components illustrated. FIG. 1 depicts the computing device 10 in an exemplary operating environment 12 in which the computing device 10 may be disposed in a networked configuration. Although many components of the operating environment 12 and the computing device 10 are not shown or described herein, it is appreciated that such components and their interconnection are well known. Accordingly, additional details concerning the construction of the operating environment 12 and the computing device 10 are not further disclosed herein.

Embodiments of the invention may be practiced in a variety of system configurations, including mobile devices, hand-held devices, consumer electronics, general-purpose computers, specialty computing devices, and the like. The computing device 10 is inclusive of devices referred to as workstations, servers, desktops, laptops, tablets, mobile devices, hand-held devices, and the like as all are contemplated within the scope of FIG. 1 and in references to the computing device 10.

Embodiments of the invention may be practiced by one or more stand-alone computing devices as depicted in FIG. 1 in distributed computing environments where one or more tasks are performed by a remote-computing device 14 that is linked through a communications network 16. The remote-computing device 14 comprises one or more computing devices that may be configured like the computing device 10 or in another manner known in the art. An exemplary computer network 16 may include, without limitation, local area networks (LANs) and/or wide area networks (WANs). Such networking environments are commonplace in offices, enterprise-wide computer networks, intranets, and the Internet. When utilized in a WAN networking environment, the computing device 10 may include a modem or other means for establishing communications over the WAN. In a networked environment, program modules or portions thereof may be stored in association with the computing device 10, a database 18, or one or more remote-computing devices 14. For example, and not limitation, various application programs may reside on memory associated with any one or more of the remote-computing devices 14. It will be appreciated that the network connections shown are exemplary and other means of establishing a communications link between the computers (e.g., the computing device 10 and the remote-computing devices 14) may be utilized.

Embodiments of the invention and/or applications that form all or a portion thereof may be described in the general context of computer code or machine-useable instructions, including computer-executable instructions, such as program modules being executed by a computer or other machine, like a smartphone, tablet computer, or other device. Generally, program modules including routines, programs, objects, components, data structures, or the like, refers to code that performs particular tasks or implements particular abstract data types.

With continued reference to FIG. 1, the computing device 10 includes one or more system busses 20, such as an address bus, a peripheral bus, a local bus, a data bus, or the like, that directly or indirectly couple components of the computing device 10. The bus 20 may comprise, for example, an Industry Standard Architecture (ISA) bus, Micro Channel Architecture (MCA) bus, Enhanced ISA (EISA) bus, Video Electronic Standards Association (VESA) local bus, a Peripheral Component Interconnect (PCI) bus, among other bus architectures available in the art.

The bus 20 couples components like internal memories 22, processors 24, display components 26, input/output (I/O) ports 28 and I/O components 30 coupled thereto, and a power supply 32. Such components may be provided singly, in multiples, or not at all as desired in a particular configuration of the computing device 10. As indicated previously, additional components might also be included in the computing device 10 but are not shown or described herein so as not to obscure embodiments of the invention. Such components are understood as being within the scope of embodiments of the invention described herein.

The memory 22 of the computing device 10 typically comprises a variety of non-transitory computer-readable media in the form of volatile and/or nonvolatile memory that may be removable, non-removable, or a combination thereof. Computer-readable media include computer-storage media and computer-storage devices and are mutually exclusive of communication media, e.g. carrier waves, signals, and the like. By way of example, and not limitation, computer-readable media may comprise Random Access Memory (RAM); Read-Only Memory (ROM); Electronically Erasable Programmable Read-Only Memory (EEPROM); flash memory or other memory technologies; compact disc read-only memory (CDROM), digital versatile disks (DVD) or other optical or holographic media; magnetic cassettes, magnetic tape, magnetic disk storage or other magnetic storage devices, or any other medium that can be used to encode desired information and be accessed by the computing device 10.

The processor 24 reads data from various entities such as the memory 22 or the I/O components 30 and carries out instructions embodied thereon or provided thereby.

The display component 26 presents data indications to a user or other device. Exemplary presentation components include a display device, a monitor, a video screen, a television screen, a speaker, a printing component, a vibrating component, or other component that produces an output that is recognizable by a user.

The I/O ports 28 allow the computing device 10 to be logically coupled to other devices including the I/O components 30, some of which may be built in. Illustrative components include a keyboard, mouse, track pad, microphone, joystick, game pad, satellite dish, scanner, printer, or wireless device, among others.

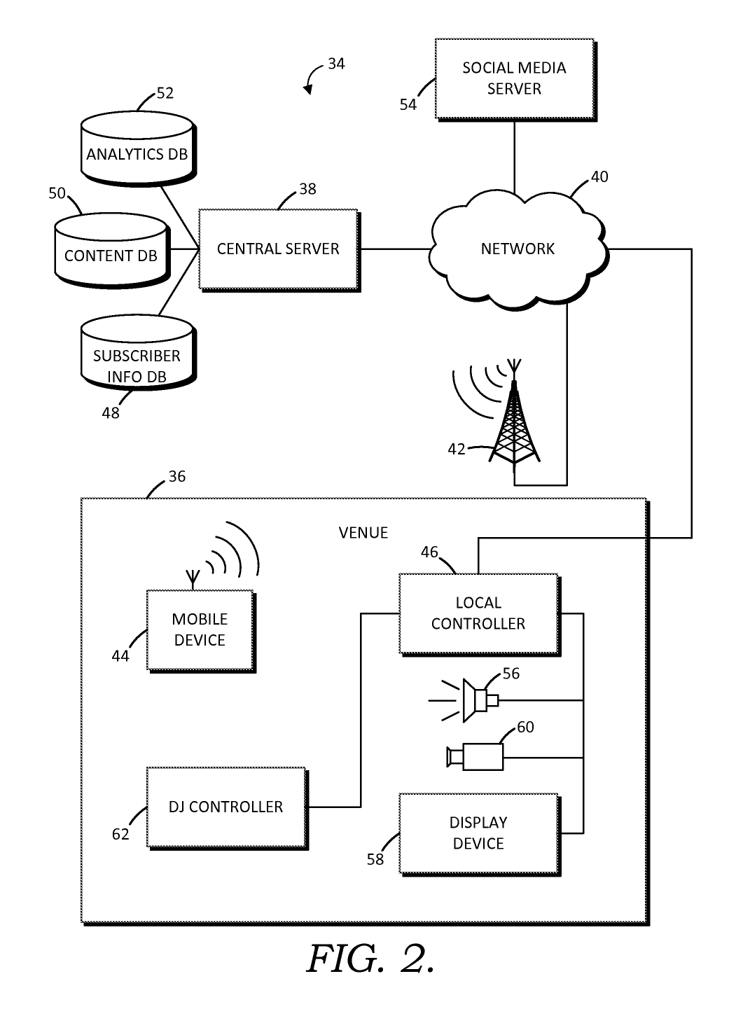

With reference now to FIG. 2, an interactive jukebox system 34 is described in accordance with an embodiment of the invention. For sake of discussion, the system 34 can be broken down into a remote portion that includes components typically located outside of and/or disparate from a venue 36 and a local portion that includes components located at the venue 36; such a breakdown is exemplary and is not intended to limit the system 34. The venue 36 includes any commercial or non-commercial establishment at which audio, audiovisual, video, graphical, or other content (generally referred to herein as content) is desired to be broadcast or otherwise presented. For example the venue 36 may comprise a restaurant, dance club, bar, casino, sporting arena, or a stadium, among a variety of other establishments.

The remote portion includes a central server 38 that is communicatively coupled to a network 40, such as a LAN or WAN, the Internet, or other network as described with respect to the network 16 of FIG. 1. As known in the art, the network 40 is accessible by wired and/or wireless communications; one or more antennas 42 may be provided to enable wireless access to the network 40 by a variety of mobile devices, such as a mobile device 44 described below.

The central server 38 comprises one or more computing devices, such as the computing device 10, and is configured to manage and execute collection, storage, and provision of data and content, among other tasks, for operation of the interactive jukebox system 34 of embodiments of the invention as described below. In one embodiment, the central server 38 includes a media server, such as the open-source Red5 media streaming server, among others, that is capable of streaming content to a local controller 46 located at the venue 36. The central server 38 is preferably configured to serve a plurality of local controllers 46 that are each located at one of a plurality of discrete venues 36. The venues 36 may be disparately geographically located from the central server 38 and other venues 36 in the plurality.

The central server 38 is communicatively coupled directly or indirectly to one or more databases or memories for storing, accessing, and transmitting data and content to/from the mobile device 44 and the local controller 46. Such databases may include a subscriber information database 48, a content database 50, and an analytics database 52. The subscriber information database 48 includes data associated with subscribers, e.g. venues 36, that have subscribed for provision of the interactive jukebox system and details of their subscriptions, payment methods, account status, and the like. The database 48 may also include one or more files associated with webpages created by or for the subscribers for publishing and access via the Internet.

The content database 50 includes the content that may be provided for broadcast at the venue 36. The content database 50 may be directly accessed by the central server 38 or may be provided by one or more third-party content providers under a license or other usage agreement. Embodiments of the invention are described herein with respect to provision of audio content, such as a recording of a song or music, for broadcast or playback at a venue, however the content that can be provided is not so limited. The content may include any audio, audiovisual, visual, graphic, or other content that can be broadcast or presented at the venue (hereinafter referred to collectively as content). The content can be communicated between the various components described herein and/or stored in any available format, such as, for example and not limitation, MP3 (Moving Picture Experts Group (MPEG) 2 audio layer III), WAV (Waveform Audio File Format), or AIFF (Audio Interchange File Format), among others.

As used herein, the terms broadcast or broadcasting, are intended to include any form of audible or visibly perceptible reproduction of content comprising audio and/or visual content. For example, broadcasting content may include playback of a song or music content via one or more speakers or other sound emitting devices or display of video or audiovisual content on a video monitor.

The analytics database 52 includes data collected by the central server 38. The collected data may include metrics associated with the audio content provided to the venue 36, requests for the audio content received from patrons of the venue 36, and demographic data associated with the patrons, among others.

The remote portion of the system 34 may also include one or more social media servers 54 or other third-party servers/computing devices that are accessible via the network 40 by the central server 38 and/or the mobile device 44. The central server 38 and/or the mobile device 44 may communicate with the social media server 54 to have data, advertisements, posts, messages, or the like published by the social media server 54 via one or more accounts associated with the venue 36, a patron, or with a provider of the interactive jukebox system 34 of embodiments of the invention.

The local portion of the system 34 includes components physically located at the venue 36. Location of a component at the venue 36 can be defined as being located within the physical walls or structure of the venue 36, within an immediate vicinity of the venue 36, e.g. within a patio, sidewalk, or parking lot associated with the venue 36, or within a predetermined radius or distance from the venue 36. The local portion includes the mobile device 44, the local controller 46, a sound system 56, and a display device 58.

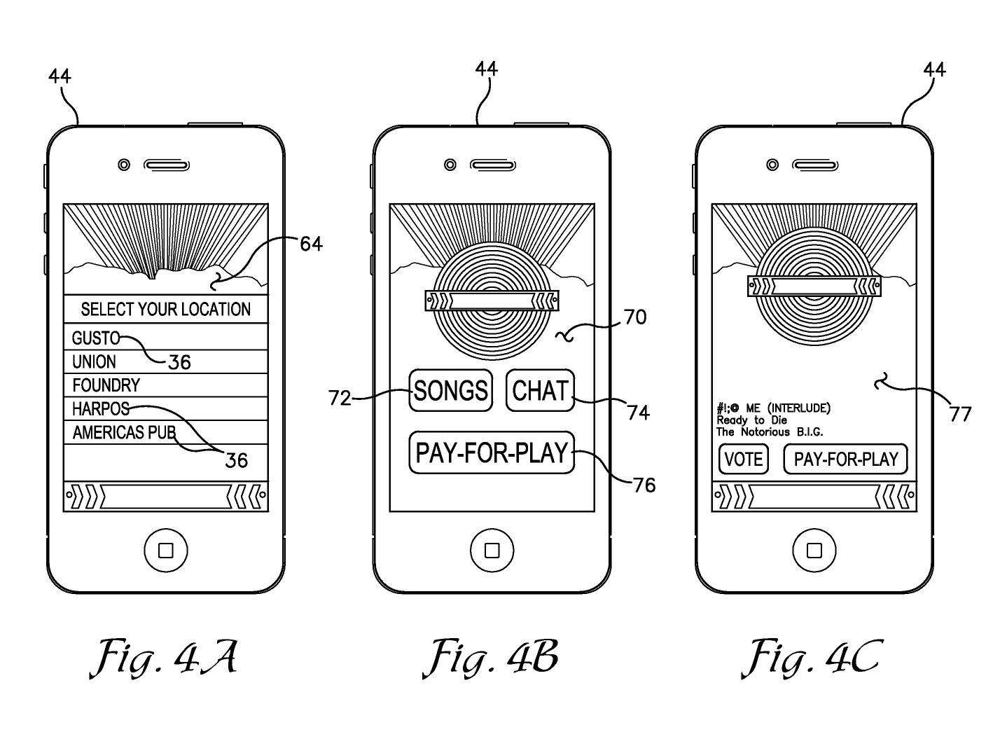

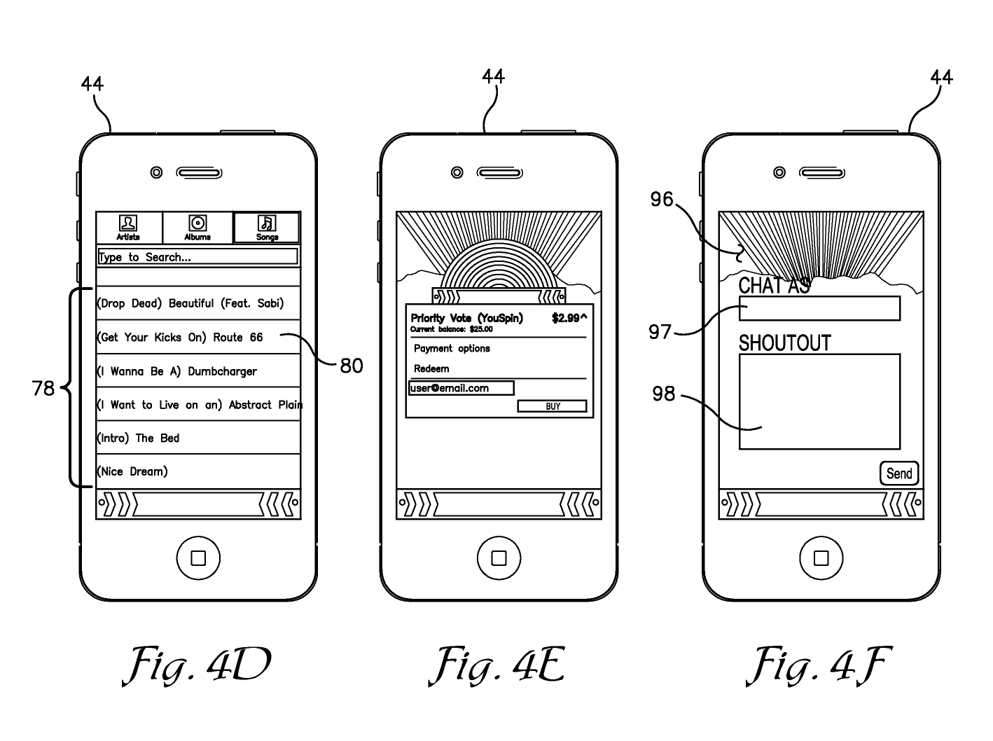

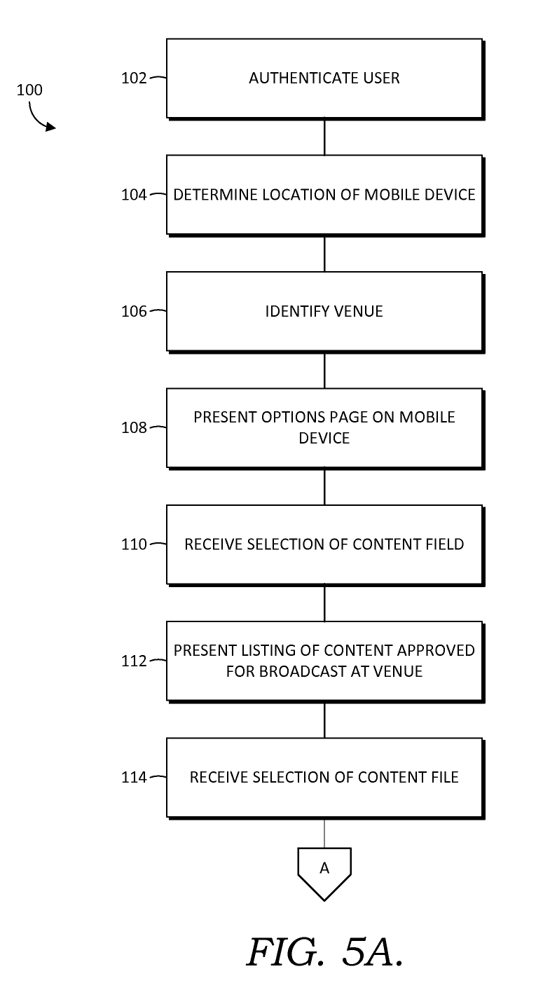

With additional reference to FIGS. 4A-4F, the mobile device 44 preferably comprises a smartphone such as an IPHONE provided by Apple Inc. of Cupertino, Calif. or one of various devices like the GALAXY mobile computing devices provided by Samsung Electronics Company, Ltd. of South Korea that operate using the ANDROID operating system from Google Inc. of Mountain View, Calif. among a variety of other mobile computing devices and operating systems. The mobile device 44 may also comprise a tablet computing device, laptop computer, personal digital assistant, or any other wireless computing device that can communicate with the central server 38 via the network 40. The mobile device 44 may access the network 40 directly via the communications tower 42, or a connection to the network 40 can be provided at the venue 36, such as through a WiFi connection.

An application is installed on and executed by the mobile device 44 to provide interaction between the mobile device 44 and the central server 38. The application provides determination of a physical location of the mobile device 44, communication of available content approved for broadcast at a given venue 36 to the mobile device 44, receipt of selections of content desired for broadcast at the venue 36 from the mobile device 44, and receipt of messages from the mobile device 44 for display at the venue 36, among other information that can be communicated between the mobile device 44 and the central server 38. The functionality is described in greater detail below.

It is understood, that the mobile device 44 is used and/or operated by a user; information communicated to the mobile device 44 and inputs received from the mobile device 44 are thus communicated to/from the user via the mobile device 44. Accordingly, for sake of simplicity, such communications and inputs are described herein relative to the mobile device 44 without reference to the user. For example, a selection of content to be broadcast is described as being received from the mobile device 44 while it is understood that the user of the mobile device 44 is actually making the selection via the mobile device 44.

The local controller 46 comprises a computing device, such as the computing device 10 and may be specially configured in a novel way to carry out the particular functions required for provision of the interactive jukebox system 34. For example, the local controller 46 might be configured to provide high-performance audio and video streaming capabilities but without a great deal of internal memory for storing content, programs, or other data. In one embodiment, the local controller 46 is constructed based on a hardware platform similar to that of a RASPBERRY PI developed by the Raspberry Pi Foundation of the United Kingdom. The local controller 46 includes one or more communications ports configured to enable connection to the network 40, the sound system 56, and the display device 58. These connections are preferably hard connections or wired connections to ensure signal quality and continuity, but wireless communications may be utilized.

The sound system 56 comprises an available sound or audio system that includes one or more speakers or other sound production devices disposed at the venue 36. The sound system 56 may also include one or more tuners, amplifiers, mixing boards, or the like.

The display device 58 includes one or more available video screens, monitors, projectors, or other video display devices configured to present a dashboard display generated by the local controller 46 or by the central server 38. A plurality of the display devices 58 can be installed at the venue 36, such as in each of a number of different rooms or at different locations within a single room.

A recording device 60 may be provided in association with the display device 58 or at the venue 36 generally. The recording device 60 includes an available recording device, such as a video camera, configured to capture video and/or audio at the venue 36. The captured content may be saved to a memory or may be streamed or communicated the display device 58 for presentation at the venue 36 or to another display device 58 for presentation at another venue 36. The local controller 46 and/or the central server 38 may control presentation, streaming, and storage of the content captured by the recording device 60.

A disc jockey (DJ) controller 62 may be provided at the venue 36. The device 62 comprises a computing device, such as the computing device 10, that is designated for use by a DJ at the venue 36 for selecting content to be broadcast. The DJ controller 62 may include a display device that presents a listing of available content, a listing of content selected by patrons of the venue 36. The DJ controller 62 also includes an interface, such as a touch-screen, keyboard, mouse, or the like, that enables interactions between the DJ and the local controller 46 or central server 38 for selection and management of content broadcasting. The DJ controller 62 may be incorporated into or associated with other DJ systems such as mixing boards, sequencers, effects units, lighting units, smoke emitters, and the like to allow the DJ to control other aspects of user's experience at the venue 36.

Operation and Setup of the Interactive Jukebox System 34 will now be described in accordance with an embodiment of the invention. The interactive jukebox system 34 may be provided as a subscription-based service. An owner or proprietor of the venue 36 who wishes to provide content to patrons at the venue 36 using the interactive jukebox system 34 may do so by subscribing to the service, such as through a website of the provider. In setting up an account, the owner of the venue 36 may be required to register for service and set up a payment plan online. Once the account has been established, the owner—now a subscriber—will be entitled to receive and broadcast musical and audiovisual content that is streamed or otherwise communicated to the local controller 46 by the central server 38 from a content library, such as the content database 50.

The subscriber may also be enabled to tailor the content that is made available for broadcast at the venue 36. Each venue 36 served by the interactive jukebox system 34 and the central server 38 can thus be provided with a unique selection of content. For example, the subscriber may select a variety of individual content files, e.g. songs, one or more genres, artists, or other collections of content that are approved for broadcast at the venue 36. Or the subscriber may allow broadcast of any available content on the central server 38 or content database 50. Accordingly, subscribers can tailor their approved content based on a particular audience, theme, or other characteristic of the venue 36, e.g. a country-western bar may only approve content from the country music genre.

In one embodiment, subscribers can generate a schedule that designates times or dates during which a particular set of approved content can be selected for broadcast at the venue 36. For example, a venue 36, such as dance club, may have a schedule that permits content from a pop-music genre to be broadcast on Monday-Thursday, but that restricts the available content to '70s music on Fridays for a '70s theme night at the venue 36. The subscriber might also be enabled to access the system 34 to alter the approved content as desired.

In another embodiment, the subscriber can upload or submit content to the central server 38 for incorporation with existing content. For example, the subscriber might submit or upload content from a local artist that is not widely known and that is not already available from the central server 38 or content database 50. The uploaded content may be added to the content database 50 for access by other venues 36 served by the system 34 or may be restricted to access by only the particular venue 36 from which the content was uploaded. The subscriber may also approve content for broadcast at the venue 36 based on a designation such as local talent, up-and-coming, or similar designation.

Each subscriber may be provided with a webpage that is hosted by the provider and one or more QR (quick response) codes, bar codes, or other machine readable codes that can be scanned by the mobile device 44 to direct a browser, on the mobile device 44 or associated with the application executing thereon, to the subscriber's webpage. The webpage and code may be employed by the subscriber to provide information associated with the venue 36, promotional information, or the like to users of the system 34. It is anticipated that the codes can be displayed on the display device 58 or separately, such as on signage at the venue 36.

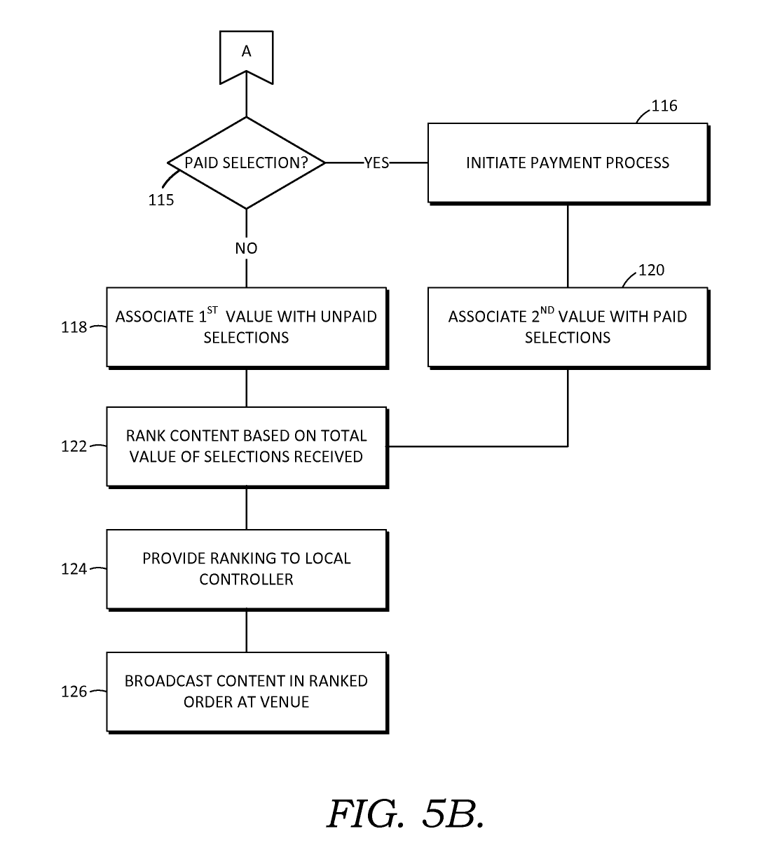

Referring now to FIGS. 5A-B, a method 100 for providing content at the venue 36 by the interactive jukebox system 34 is described in accordance with an embodiment of the invention. Initially, a user installs and executes an application associated with the interactive jukebox system 34 on a mobile device 44. The user may be required to create an account with the interactive jukebox system 34 by registering a name, contact information, a password, payment information, or the like with the system 34. The user's account might also be linked to one or more other accounts held by the user, such as a social media account or an account with an online payment service, among others.

To access the system 34, the user launches the application on the mobile device 44 which communicates with the central server 38 via the network 40 to enable the user to log in to the user's account in a manner similar to that known in the art, as shown at step 102. The location of the user/mobile device 44 is next determined to identify a particular venue 36 at which the user is now a patron, as shown at step 104.

The location of the mobile device 44 may be determined by identifying a position of the mobile device 44 using a global positioning system (GPS) integrated into the mobile device 44. A listing of one or more venues 36 that are in close proximity to the identified position of the mobile device 44 may be presented on a venue-selection page 64 on the mobile device 44 to allow selection of the particular venue 36 by the user as depicted in FIG. 4A. Or the particular venue 36 may be automatically selected based on the identified position. It is understood that other ways of determining the location of the mobile device 44 based on data collected by the mobile device 44 can be employed. For example, the location might be determined based on a scan of available signals or signal towers and the strength of those signals to triangulate the location, among other ways. All such methods are understood as falling within the scope of embodiments of the invention described herein.

The location of the mobile device 44 might also be determined based on one or more inputs received from the user, such as by selection of a location or venue from a listing provided by the central server 38. In another embodiment, the mobile device 44 is employed to scan a quick response (QR) code or other machine-readable medium, provided at the venue 36; the QR code is associated with the venue 36 and is thus useable to specifically identify the venue 36.

A particular venue 36 is identified as shown at step 106. Preferably, access of the mobile device 44 to the system 34 in association with a particular venue 36 is restricted to require the mobile device 44 to be located at the venue 36. Accordingly, the mobile device 44 is prevented from performing one or more of the below described method steps unless physically located at the venue 36.

At step 108 an options page 70 is provided on the mobile device 44, as depicted in FIG. 4B. The options page 70 includes a plurality of selectable fields including, for example, a content field 72, a messaging field 74, and a pay-for-play field 76. A variety of other fields may be provided to access additional functionalities without departing from the scope of embodiments of the invention described herein. For example, a currently-playing field (not shown) may be provided to access a current-content page 77 depicting content that is currently being broadcast at the venue 36, as shown in FIG. 4C. In another embodiment, the options page 70 may be replaced with the current-content page 77 upon an expiration of a predetermined period of time without receiving a user input to the options page 70 or via a swipe or other gesture or input to the options page 70. Although a particular exemplary configuration of the application executing on the mobile device 44 and the user interface presented thereby is described herein, such is not intended to limit embodiments of the invention to any particular configuration.

The content field 72 may be selected as depicted at step 110. A listing 78 of content that has been approved by the subscriber for broadcast at the venue 36 is presented on the mobile device 44 at step 112 and as shown in FIG. 4D. The listing 78 may be communicated to the mobile device 44 automatically upon identification of the mobile device 44 as being at the particular venue 36 (step 106) or upon selection of the content field 72 by the user (step 110). The listing can be searched, organized, sorted, or otherwise manipulated to locate content that the user wishes to have broadcast at the venue 36. At step 114, the user selects a particular content file 80 to be broadcast at the venue 36; the selection is made via the mobile device 44.

Continuing to FIG. 5B, the selection of the content file 80 may be an unpaid or a paid selection, as shown at block 115. The selection operates similarly to a vote for the content file 80. The selection is communicated to the central server 38 which records, accumulates, or tallies the selections received from one or more mobile devices 44 at the venue 36.

Preferably, the selections are tallied with respect to the particular venue 36 at which the mobile devices 44 providing the selections are located. Accordingly, users/patrons of the particular venue 36 only have input into the content broadcast at the particular venue 36 and not at other venues 36 that are served by the interactive jukebox system 34. In another embodiment, selections from a plurality of venues 36 are recorded and accumulated together so as to affect the content broadcast at each of the venues 36 in the plurality. For example, selections from a plurality of venues 36 owned by a single subscriber or of a similar theme might be combined to provide a similar content broadcast experience at each of the venues 36.

If a selection is designated as a paid selection, the central server 38 initiates a payment process based on payment information stored in the user's account or collected from the user at the time of the selection, as indicated at step 116 and depicted in FIG. 4E. The payment process can include a debit to a prepaid account, a charge to a bank account, a charge to a credit account, or other available payment means. The application may present a “pay-for-play” field 76 on the mobile device 44 on the options page 70, in association with the listing 78 of content, and/or on another page presented in association with the selected content file 80, among other locations.

The selections are each provided with a value. Unpaid selections are given a first value, such as a value of “1”, as depicted at step 118. In an embodiment, unpaid selections can be positive selection or a negative selection, e.g. a thumbs-up or a thumbs-down. In such embodiments, a positive selection may be given a positive value (e.g. +1) while a negative selection is given a negative value (e.g. −1 or −0.5), which may be of the same or different magnitude as the positive value. Accordingly, the user can not only promote content that he or she wishes to hear, but also demote content that he/she does not want to hear.

Paid selections are given a value greater than that given to unpaid selections such that paid selections are more strongly promoted and more likely to be broadcast at the venue 36, as depicted at step 120. For example, paid selections might be given a value of “10” or “100” while unpaid selections are given a value of “1” or “0.1.” In one embodiment, various levels of paid selections are provided in which the user can select from one or more monetary amounts to be paid each having a respective value that is given to the selection, such that the user can choose to pay more to increase the likelihood of the content being broadcast at the venue 36. In another embodiment, a paid selection is automatically queued for broadcasting at a next available slot, e.g. the paid selection is broadcast following the completion of any content currently being broadcast; multiple paid selections may be ordered for broadcast based on the order in which they are received.

The value associated with each selection may be a constant value or may decay with respect to time. An algorithm, such as an exponential decay function may be used to determine the value of each selection based on an initial value and an amount of time that has passed since the selection was made or received. Accordingly, the selections affecting the total value associated with the selected content file 80 can be restricted to only those that have been recently received, e.g. selections made days, weeks, or months earlier can reduced in value to “0” or removed from the tally total altogether. Devaluation aids to ensure that the most recent selections are given the greatest weight and that current patrons of the venue 36 are provided with the greatest control over the content that is broadcast.

With continued reference to FIG. 5B, the central server 38 determines a total value of the selections—paid and unpaid—received in association with each content file from mobile devices 44 at the venue 36 and generates a ranking of the content files based on the total values, as depicted at step 122. The ranking of the content files is provided to the local controller 46 at the venue 36 at step 124. Alternatively, a ranking previously communicated to the local controller 46 may be updated based on a new/most recent set of values. The ranking may be updated continuously in real-time, at a predetermined interval of time, sporadically, or upon demand. At step 126, the local controller 46 broadcasts the content files at the venue 36 via the sound system 56 and/or the display device 58 in the order provided by the ranking

The broadcast of the content at the venue 36 may be completed by the local controller 46 streaming the content from the central server 38 or the content database 50 in real-time. Or the content may be at least partially buffered or cached ahead of time at the local controller 46 (e.g. in an associated memory).

After the selected content file 80 is broadcast at the venue 36, the total value of the selections received therefor may be reduced to “0” or an algorithm can be applied to reduce the value by another amount such that the same content file is not repeatedly broadcast in a short timespan at the venue 36. Alternatively or in addition, the system 34 may restrict the broadcasting of the selected content file 80 from being rebroadcast within a predetermined period of time.

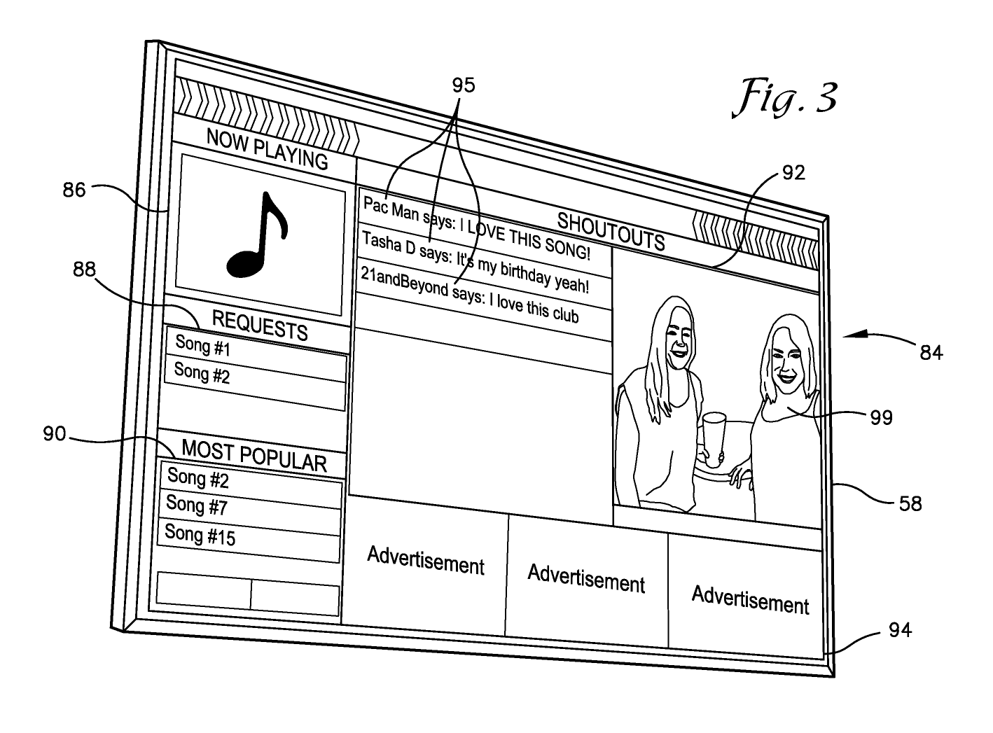

With additional reference now to FIG. 3, the local controller 46 also generates a dashboard display 84 on the display device 58 at the venue 36. The dashboard display 84 can be configured to include a variety of fields in which information associated with the content, users, and venue 36, among others may be displayed. For example, the dashboard display 84 may include a current-content field 86, a content queue 88, a popular content field 90, a messaging field 92, an advertisements banner 94. As shown in FIG. 3, the current-content field 86 includes a visual representation of the content that is currently being broadcast at the venue 36, e.g. an album cover or other artwork and a textual banner listing the name of a specific song.

The content queue 88 presents at least a portion of the content ranking received from the central server 38 to notify patrons of the venue 36 what content they can expect for broadcast. The popular content field 90 may present a selection of content files that have received the most selections (e.g. votes) over a recent time period either at the venue 36 or at a plurality of venues 36. The popular content field 90 might also employ data from other sources to identify popular content for display.

The messaging field 92 is populated with one or more textual or graphic posts 95 or messages generated by patrons of the venue 36 or multiple venues 36 via their mobile devices 44, as described more fully below.

The advertisements banner 94 includes one or more sections of the dashboard display 84 that may be filled with advertisements or information from any desired source. For example, the advertisements may be for products sold at the venue 36, the venue 36 itself, associated venues 36, or other products and services. The advertisements banner 94 as well as the other fields 86, 88, 90, 92 may be arranged and organized on the dashboard display 84 in any manner. The layout depicted by FIG. 3 is only one exemplary organization of the dashboard display 84 and is not intended to limit embodiments of the invention.

As shown in FIG. 3, in one embodiment, the dashboard display 84 might also include one or more video fields 99 in which video content captured by the recording device 60 located at the venue 36 or at another venue 36 is displayed or in which video content that is selected for broadcast by patrons may be presented. For example, a live video stream from another venue 36 might be displayed in the video field 99 to engage patrons of both venues 36 in a competition between venues 36, or a live video stream from another area of the particular venue 36 might be displayed to enable viewing or participation in an event throughout the venue 36. The video field 99 might also be employed to display one or more graphical images or posts received from the mobile device 44 at the venue 36.

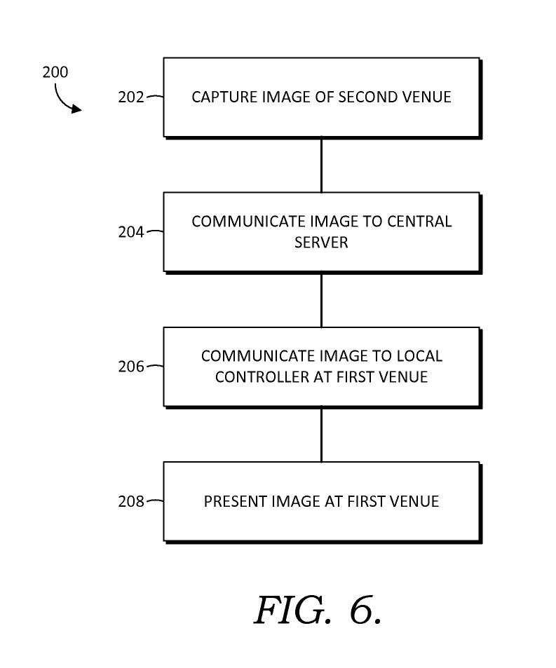

As depicted in FIG. 6, a method 200 for presenting a captured video steam is described in accordance with an embodiment of the invention. At a step 202, a video image is captured by a camera located at a second venue. The video image is streamed or otherwise communicated by a local controller at the second venue to the central server 38, as indicated at step 204. The central server 38 communicates the video image to the local controller 46 at the venue 36, at step 206, and the local controller 46 presents at least a portion of the video image in the video field 99 of the dashboard display 84 on the display device 58, at step 208. The reverse process might also be completed to present a video image captured by the recording device 60 at the venue 36 on a display device at another venue.

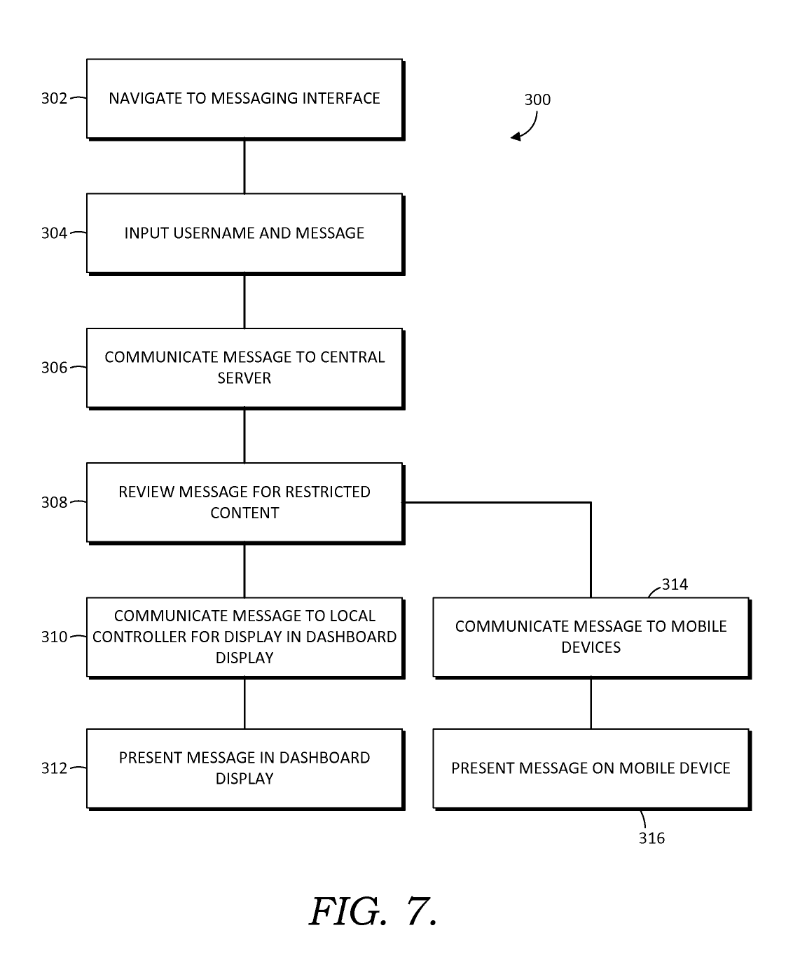

With additional reference to FIG. 7, a method 300 for presenting messages posted by patrons of the venue 36 is described in accordance with an embodiment of the invention. As shown in FIG. 4F, the application executing on the mobile device 44 provides a messaging interface 96 that is accessible by the user selecting the messaging field 74 on the options page 70, as indicated at step 302. The messaging interface 96 enables the user to provide a username to be associated with their post 95 and to input a textual or graphical message via open fields 97 and 98, as indicated at step 304. A graphical message may comprise one or more images captured by a camera on the mobile device 44 or stored in a memory that is accessible by the mobile device 44.

Following inputting of the username and message, the data is transmitted to the central server 38, as indicated at step 306. At step 308, the central server 38 may perform one or more review tasks on the message to, for example, ensure that the content contained in the message is acceptable for display by the display device 58 on the dashboard display 84, e.g. vulgar or sexually explicit content may be restricted or filtered. The central server 38 then communicates the post to the local controller 46, as indicated at step 310. At least a portion of the message is then displayed in the dashboard display 84, as indicated at step 312. The messages or posts 95 displayed in the messaging field 92 may be presented on a scrolling list on a first-in-first-out basis, among a variety of other available presentations. Graphical images associated with one or more of the posts 95 can be displayed in the video field 99 or, for example, alongside the textual content of the post 95. Display of the graphical images in the video field 99 may enable the image to be displayed on a larger scale and thus be more visible to patrons at the venue 36.

In another embodiment, the central server 38 communicates at least a portion of the username and message to one or more mobile devices 44 of other users at the venue 36, as indicated at step 314. The application executing on each of the other mobile devices 44 may present all or a portion of the username and message on the associated mobile devices 44 in a manner similar to the display on the dashboard display 84, as indicated at step 316.

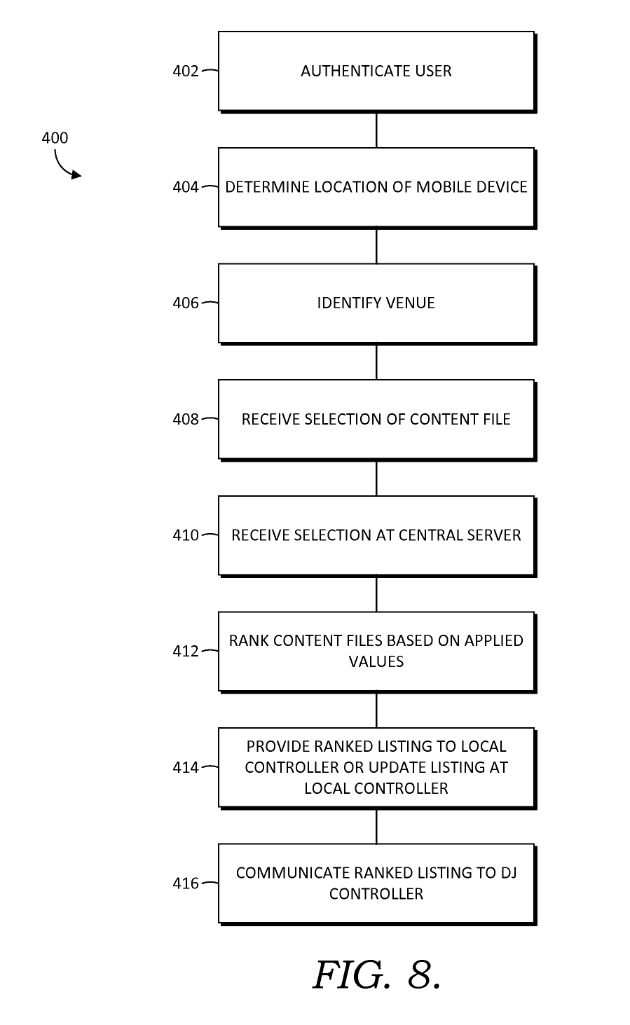

With reference now to FIG. 8, a method 400 for operation of the interactive jukebox system 34 in a DJ mode is described in accordance with an embodiment of the invention. Operation of the system 34 in DJ mode at least partially overlaps with the operation described above with respect to the method 100. Accordingly, those steps that are similar are not described again below in great detail. As in the non-DJ mode operation described above, a user is authenticated at step 402, a location of the mobile device 44 is identified at step 404, and a particular venue is identified at step 406. The user/patron selects a desired content file 80 at step 408 which is communicated to the central server 38 at step 410. The central server 38 ranks the selected content files 80 based on values applied thereto at step 412.

At step 414 the ranked listing of content files is provided to the local controller 46 or a previously provided listing is updated. The local controller 46 communicates the ranked listing to the DJ controller 62 for viewing and use by a DJ at step 416. The DJ selects content files from the ranked listing for broadcast at the venue 36. The DJ may also control a variety of effects, lighting, and other aspects of the broadcast and presentation at the venue 36 via the DJ controller 62.

Communication of content requests to the DJ by way of the ranked listing provides a novel means of communication between patrons of the venue 36 and the DJ. Typically, to request a particular content for broadcast, e.g. request a song, a patron of the venue 36 must make his/her way through a crowd of people to the DJ and speak directly to the DJ. Such direct communications can be very difficult in a crowded venue 36 in which music is playing loudly; the DJ may be unable to adequately hear the request and/or the patron may simply decide not to pursue making the request. And such spoken requests may not reflect the interests of the patrons of the venue 36 as a whole.

Conversely, submission of requests via the interactive jukebox system 34 and provision of the ranked listing of these requests to the DJ greatly increases the ease with which patrons can submit their requests and the likelihood that they will do so. Ranking of the submitted requests further increases the likelihood that the requested content is of interest to patrons of the venue 36 as a whole and provides the DJ with a substantial tool to aid selection of content for broadcast. Accordingly, the DJ is better informed of the tastes of the patrons and the patrons enjoyment of content broadcast is increased.

Control of content to be broadcast by the DJ may be configured in a variety of ways. For example, the DJ may be provided with full authority to choose content to be broadcast using the provided content listing only as a reference for his/her use. Or the DJ may be restricted completely or partially to selection of content from the ranked listing. In one embodiment, the DJ is required to select content from, for example, a top ten set of the ranked content files in the ranked listing. In another embodiment, the DJ is required to select at least a predetermined ratio of content files from the top ten ranked content files, e.g. the DJ must select at least one content file from the top ten ranked content files for every two content files broadcast that are not in the top ten ranked content files. A variety of other configurations may be employed without departing from the scope of embodiments of the invention described herein.

Generally, the pay-for-play option is not made available when the system 34 is operating in DJ mode. In one embodiment, patrons may elect to pay for prioritized play of a selected content file when the system 34 is operating in DJ mode. In this instance, the DJ may be required by the system 34 to broadcast the paid-for-content. Or the DJ may be authorized to broadcast the paid-for-content as he/she sees fit. In one embodiment, paid-for-content that is not broadcast during operation of the system 34 in DJ mode is refunded or not charged to the patron.

With reference again to FIG. 2, in one embodiment of the invention the interactive juke box system 34 may include and/or be in communication with one or more social media servers 54. As such, the account created by the user may be linked to a social media account of the user and data associated with the user's accounts may be at least partially shared between the system 34 and the social media server 54. For example, the user may be enabled to log in to their account with the system 34 via their social medial account and have portions of their social media profile used with their interactions with the system 34, e.g. a representative image and a user name of the user from the social media account may be employed or presented with any posts made to the dashboard display 84 via the system 34. Interactions of the user with the system 34 may also be posted to the user's social media account. The application executing on the mobile device 44 may provide cross-functionalities or access between the system 34 and the social media server 54.

Embodiments of the invention may collect analytics and/or statistics related to usage of the system 34, users, content, and the like. The analytics/statistics data may include, for example and not limitation, demographic data of the users, content selections, date and time information associated with selections, information associated with where and when content is broadcast, among a variety of other collectable data points. Such information may be employed by the system 34 to tailor and maximize advertising effectiveness and revenue, improve the operation of the system 34, or for sale to other third-party entities.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to demarcate those structures as including a plurality of possible arrangements or designs within the scope of this disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

What is claimed is:

1. A method for providing content for broadcast at a venue, the method comprising:
determining a physical location of a mobile device to be within a venue;
enabling interaction between the mobile device and a central server;
receiving, by the central server from the mobile device, an indication associated with a selected content file;
ranking the selected content file relative to a plurality of other content files based on the indication;
transmitting a representation of the ranking to a local controller device located at the venue, the representation being presented at the venue for selection of one or more of the selected content file and the other content files for broadcast at the venue;
receiving, via the local controller, a selection of the selected content file; and
broadcasting the selected content file via a sound system located at the venue.

2. The method of claim 1, further comprising:
presenting at least a portion of the representation on a visual display in the venue.

3. The method of claim 1, wherein enabling interaction between the mobile device and the central server further comprises:
providing to the mobile device, a list of a plurality of content files that are approved for broadcasting at the venue, the list including the selected content file and the plurality of other content files.

4. The method of claim 1, wherein ranking the selected content file relative to the other content files further comprises:
associating a value with the indication;
summing the values of a plurality of indications associated with each of a plurality of content files that are approved for broadcasting in the venue; and
ordering the plurality of content files based on the respective summed values.

5. The method of claim 4, wherein the value is a decaying value that decreases with respect to time.

6. The method of claim 5, wherein the value decays exponentially.

7. The method of claim 5, wherein the indication is accompanied by an authorization to charge a fee, and wherein the value associated with the fee-accompanied-indication is greater than the value associated with a non-fee-accompanied-indication.

8. The method of claim 1, further comprising:
receiving, by the central server, a post from the mobile device;
communicating the post to the local controller device;
presenting at least a portion of the post on a display device located at the venue by the local controller device.

9. The method of claim 8, wherein the post includes an image file captured by the mobile device.

10. The method of claim 8, further comprising:
communicating at least a portion of the post, by the central server, to one or more second mobile devices located at the venue; and
presenting the at least a portion of the post on the one or more second mobile devices.

11. The method of claim 1, wherein the local controller is a first local controller and the venue is a first venue, and further comprising:
receiving, by the central server, a streaming video feed from a second local controller located at a second venue;
communicating the streaming video feed to the first local controller; and
presenting the streaming video feed at the first venue on a display device.

12. A visual display system at a venue that presents information associated with audio content broadcasting in the venue; the visual display system comprising:
a local controller device located at the venue and communicatively coupled to a remotely-located central server and to an audio system for reproduction of an audio content file at the venue;
a visual display device located at the venue and communicatively coupled to the local controller; and
a dashboard display presented on the visual display device, the dashboard display including:
a broadcast field including a visual indication of the audio content file currently being broadcast via the audio system by the local controller device, and
a messaging field that includes a visual representation of one or more messages posted by a patron of the venue, the message being posted by the patron using a mobile device located at the venue and communicated to the local controller device via the remotely-located central server.

13. The visual display system of claim 12, wherein the message includes an image captured by the patron using the mobile device.

14. The visual display system of claim 12, wherein the venue comprises a first venue and the dashboard display includes a video-display field in which a streaming video is presented, the streaming video being captured by a camera located at a second venue.

15. The visual display system of claim 14, wherein the second venue includes a second visual display device with a second dashboard display that includes a second video-display field in which a second streaming video is presented, the second streaming video being captured by a camera located at the first venue.

16. The visual display system of claim 12, wherein the dashboard display includes a content queue field in which a representation of a plurality of audio content files is provided in a ranked order in which the audio content files will be broadcast at the venue.

17. The visual display system of claim 16, wherein the ranked order of the plurality of audio content files is determined based on a plurality of selections of one or more of the plurality of audio content files received by the central server from the mobile device and one or more second mobile devices at the venue.

18. A method for providing content for broadcast at a venue, the method comprising:
determining a physical location of a mobile device to be within a venue;
enabling interaction between the mobile device and a central server;
receiving, by the central server from the mobile device, an indication associated with a first content file;
ranking the first content file relative to a plurality of second content files based on the indication;
transmitting a representation of the ranking to a local controller device located at the venue;
broadcasting, by the local controller using an audio system located at the venue, one or more of the first and second content files in an order determined by the ranking.

19. The method of claim 18, wherein enabling interaction between the mobile device and the central server further comprises:
providing to the mobile device, a list of the second content files, the second content files including the first content file and the second content files being approved for broadcasting at the venue.

20. The method of claim 18, further comprising:
receiving, by the central server, a post from the mobile device;
communicating the post to the local controller device;
presenting, by the local controller device, at least a portion of the post on a display device located at the venue.
